(19) United States
(12) Patent Application Publication
(10) Pub. No.: US 2020/0302115 A1
(43) Pub. Date: Sep. 24, 2020

(54) LINKING AND COMPOSING WORKSHEETS

(71) Applicant: SIGMA COMPUTING, INC., San Francisco, CA (US)

(72) Inventors: JAMES L. GALE, SAN FRANCISCO, CA (US); KENNETH TRUONG, TEMPLE CITY, CA (US); MAX H. SEIDEN, SAN FRANCISCO, CA (US); JASON D. FRANTZ, SAN FRANCISCO, CA (US)

(21) Appl. No.: 16/823,317

(22) Filed: Mar. 18, 2020

Related U.S. Application Data
(60) Provisional application No. 62/820,456, filed on Mar. 19, 2019.

(51) Int. Cl. G06F 40/18; G06Q 10/10; G06F 16/245; G06F 16/248

(52) U.S. Cl. CPC G06F 40/18; G06F 16/248; G06F 16/245; G06Q 10/10

(57) ABSTRACT

Linking and composing worksheets including receiving a request to create a referencing worksheet linked from a data source worksheet, wherein the data source worksheet is a presentation of a data set from a database; retrieving data source worksheet metadata using a reference to the data source worksheet metadata in the request; and creating, using the data source worksheet metadata, the referencing worksheet presenting at least a subset of the data set presented by the data source worksheet, wherein creating the referencing worksheet comprises: generating a database query using the data source worksheet metadata and referencing worksheet metadata received in the request; and issuing the database query to the database.

### CROSS-REFERENCE TO RELATED APPLICATIONS

This application is a non-provisional application for patent entitled to a filing date and claiming the benefit of earlier-filed U.S. Provisional Patent Application Ser. No. 62/820,456, filed Mar. 19, 2019.

### BACKGROUND

### Field of the Invention

The field of the invention is data processing, or, more specifically, methods, apparatus, and products for linking and composing worksheets.

### Description of Related Art

Modern businesses may store large amounts of data in remote databases within cloud-based data warehouses. This data may be accessed using database query languages, such as structured query language (SQL). However, some query responses may include too much data to present efficiently in a web application.

### SUMMARY

Methods, systems, and apparatus for linking and composing worksheets. Linking and composing worksheets includes receiving a request to create a referencing worksheet linked from a data source worksheet, wherein the data source worksheet is a presentation of a data set from a database; retrieving data source worksheet metadata using a reference to the data source worksheet metadata in the request; and creating, using the data source worksheet metadata, the referencing worksheet presenting at least a subset of the data set presented by the data source worksheet, wherein creating the referencing worksheet comprises: generating a database query using the data source worksheet metadata and referencing worksheet metadata received in the request; and issuing the database query to the database.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an example system configured for linking and composing worksheets according to embodiments of the present invention.

FIG. 2 sets forth a block diagram of an example system configured for linking and composing worksheets according to embodiments of the present invention.

FIG. 3 sets forth a block diagram of an example graphical user interface configured for linking and composing worksheets according to embodiments of the present invention.

FIG. 4 sets forth a flow chart illustrating an exemplary method for linking and composing worksheets according to embodiments of the present invention.

FIG. 5 sets forth a flow chart illustrating an exemplary method for linking and composing worksheets according to embodiments of the present invention.

FIG. 6 sets forth a flow chart illustrating an exemplary method for linking and composing worksheets according to embodiments of the present invention.

FIG. 7 sets forth a flow chart illustrating an exemplary method for linking and composing worksheets according to embodiments of the present invention.

FIG. 8 sets forth a flow chart illustrating an exemplary method for linking and composing worksheets according to embodiments of the present invention.

### DETAILED DESCRIPTION

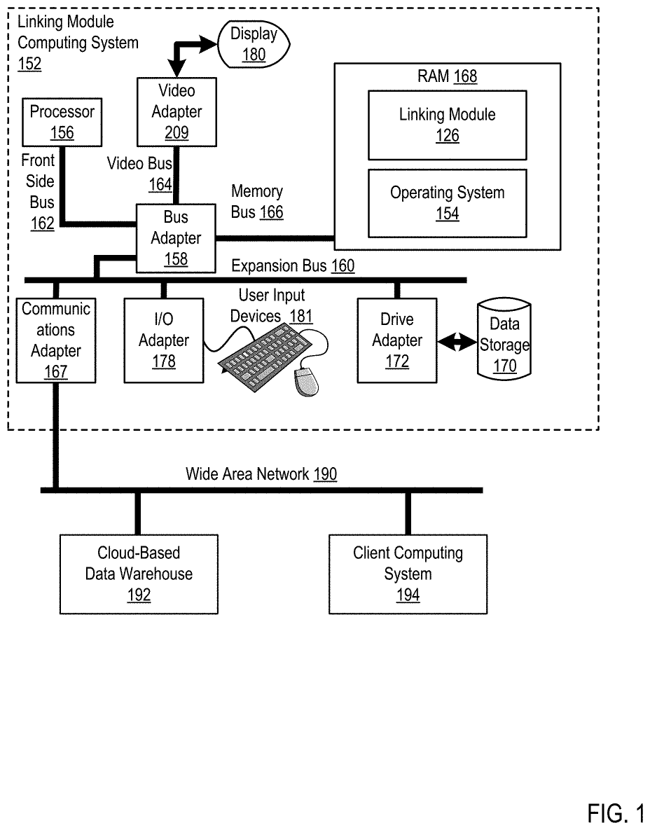

Exemplary methods, apparatus, and products for linking and composing worksheets in accordance with the present invention are described with reference to the accompanying drawings, beginning with FIG. 1. FIG. 1 sets forth a block diagram of automated computing machinery comprising an exemplary linking module computing system (152) configured for linking and composing worksheets according to embodiments of the present invention. The linking module computing system (152) of FIG. 1 includes at least one computer processor (156) or ‘CPU’ as well as random access memory (168) (RAM′) which is connected through a high speed memory bus (166) and bus adapter (158) to processor (156) and to other components of the linking module computing system (152).

Stored in RAM (168) is an operating system (154). Operating systems useful in computers configured for linking and composing worksheets according to embodiments of the present invention include UNIX™, Linux™, Microsoft Windows™, AIX™, IBM's i OS™, and others as will occur to those of skill in the art. The operating system (154) in the example of FIG. 1 is shown in RAM (168), but many components of such software typically are stored in non-volatile memory also, such as, for example, on data storage (170), such as a disk drive. Also stored in RAM is the linking module (126), a module for linking and composing worksheets according to embodiments of the present invention.

The linking module computing system (152) of FIG. 1 includes disk drive adapter (172) coupled through expansion bus (160) and bus adapter (158) to processor (156) and other components of the linking module computing system (152). Disk drive adapter (172) connects non-volatile data storage to the linking module computing system (152) in the form of data storage (170). Disk drive adapters useful in computers configured for linking and composing worksheets according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example linking module computing system (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example linking module computing system (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary linking module computing system (152) of FIG. 1 includes a communications adapter (167) for data communications with other computers and for data communications with a data communications network. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for linking and composing worksheets according to embodiments of the present invention include modems for wired dial-up communications, Ethernet (IEEE 802.3) adapters for wired data communications, and 802.11 adapters for wireless data communications.

The communications adapter (167) is communicatively coupled to a wide area network (190) that also includes a cloud-based data warehouse (192) and a client computing system (194). The cloud-based data warehouse (192) is a computing system or group of computing systems that hosts a database for access over the wide area network (190). The client computing system (194) is a computing system that accesses the database via the linking module computing system (152).

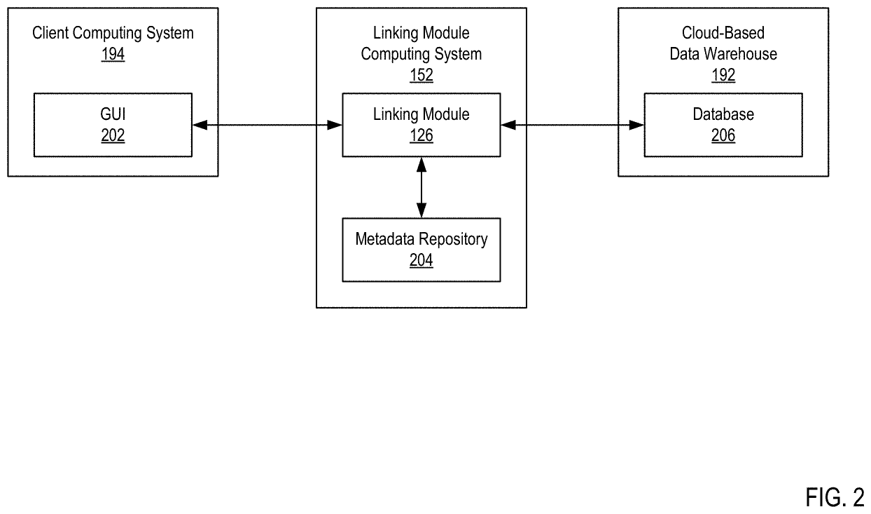

FIG. 2 shows an exemplary block diagram of a system for linking and composing worksheets according to embodiments of the present invention. As shown in FIG. 2, the system includes a client computing system (194), a linking module computing system (152), and a cloud-based data warehouse. The client computing system (194) includes a graphical user interface (GUI) (202). The linking module computing system (152) includes a linking module (126) and a metadata repository (204). The cloud-based data warehouse (192) includes a database (206).

The GUI (202) is a user interface that presents a data set and graphical elements to a user and receives user input from the user. The GUI (202) may be presented, in part, by the linking module (126) and displayed on a client computing system (194) (e.g., on a system display or mobile touchscreen). The GUI (202) may be an Internet application hosted on the linking module computing system (152) and presented on the client computing system (194).

The GUI (202) presents, in part, worksheets to a user. A worksheet is a presentation of a data set from a database (206). A referencing worksheet is a worksheet that is linked from another worksheet (referred to as a data source worksheet). The referencing worksheet inherits the data set presented in the data source worksheet (i.e., data not excluded from presentation). The referencing worksheet may also inherit the results of formula applied to other data but not the formulas themselves. The referencing worksheet may be limited to the data set presented or otherwise made available in the data source worksheet (unless the user generating the referencing worksheet has access to excluded data in the database). A referencing worksheet may be linked from any number of data sources, including multiple data source worksheets.

For example, the CFO of a corporation may have unrestricted access to a financial database for the corporation, and using the financial database, the CFO creates a data source worksheet for a salary budget. The data source worksheet may be generated from the database using a data set that includes an employee identifier column, an employee department column, an employee salary column, and a column indicating a 1-10 score given to the employee based on a subjective evaluation of the importance of that employee to the company. The CFO may create an additional calculation column that calculates a yearly bonus for the employee based, in part, on the employee subjective value column. The CFO may then sort the worksheet by employee department and create an additional calculation column that calculates the total salary and bonus budget for each department. Finally, the CFO may hide the employee salary column and the employee subjective value column so that no other users may view those columns.

Continuing with the example, an accountant at the corporation without access to the financial database may create a referencing worksheet linked from the CFOs data source worksheet. The referencing worksheet would present the employee identifier column, the employee department column, the employee yearly bonus column, and the total salary and bonus budget column. Because the employee salary column and the employee subjective value column were excluded from presentation in the data source worksheet, the referencing worksheet would not have access to the employee salary column or the employee subjective value column. Further, the referencing worksheet would only inherit the results of an applied formula and not the formula itself. Therefore, the referencing worksheet would not disclose that the yearly bonus column was calculated using the subjective value column. The account may then edit the referencing worksheet to build upon the work done by the CFO in creating the data source worksheet.

Changes made to the data source worksheet are reflected in the referencing worksheet. For example, if a column is added to and presented in the data source worksheet, the column would then appear in or be available to the referencing worksheet.

A referencing worksheet may be linked from multiple data source worksheets and each data source worksheet may itself be a referencing worksheet linked from any number of other data source worksheets. Further, a data source worksheet does not need any particular additional configuration for a referencing worksheet to be linked from that data source worksheet. For example, assume that three users create three different worksheets, worksheet A, worksheet B, and worksheet C. Worksheet C can be linked from worksheet A and worksheet B without the knowledge or cooperation of the users who created worksheet A and worksheet B. Further, the user creating worksheet C may not be authorized to view worksheet A or worksheet B, but is still able to create a referencing worksheet linked from worksheet A and worksheet B (assuming she has authorization to view the underlaying data).

The GUI presents a worksheet using the information in the worksheet metadata. Worksheet metadata, such as referencing worksheet metadata and data source metadata, is data that describes a worksheet. Specifically, the worksheet metadata may include a description of the data set, the formulas to be applied to the data set, and the presentation structure of the data set. The description of the data set describes which data is to be requested via the database query. The description of the data set may include which columns and rows of data are to be retrieved from the database (206) via the database query. The formulas to be applied to the data set may include the manipulations of the data in the columns and rows received in the data set. Such manipulations may include calculation columns that apply a formula to data in the data set.

The presentation structure of the data set may include presentation selections made by a user. The presentation structure may include the hierarchical relationship between the columns, filters applied to the data, and the manner in which the data is sorted. The presentation structure of the data set may also include the GUI visibility of particular data within the data set. GUI visibility may be altered based on filter settings of the data or on the visibility status (e.g., hidden or not hidden) of a column within the data set. The presentation structure of the data set may also include the formatting of the worksheet, such as the size of rows and columns.

Worksheet metadata may also include a reference to, or identifier of, the worksheet metadata for a different worksheet. For example, the worksheet metadata for a referencing worksheet may include a reference to the data source worksheet from which the referencing worksheet was linked. Further, referencing worksheet metadata may lack a reference to the database or data set upon which the data source worksheet was built. Rather, the referencing worksheet metadata may only include a reference to the data source worksheet metadata, and that reference is used to retrieve the data source worksheet metadata. Because the referencing worksheet metadata may lack a reference to the database or data set, both the referencing worksheet metadata and data source worksheet metadata are used to generate the database query.

The linking module (126) is hardware, software, or an aggregation of hardware and software configured to retrieve worksheet metadata, evaluation worksheet metadata, and generate a database query using the worksheet metadata. The linking module (126) may be part of a database query generator that generates the database query. The database query may be populated based on the worksheet metadata.

The metadata repository (204) is a repository of worksheet metadata. Worksheet metadata may be retrieved from the metadata repository (204) using a reference to, or identifier of, the worksheet metadata. The database (206) is a collection of data and a management system for the data. The management system may receive database queries, such as structure query language (SQL) queries, and respond to queries with a data set.

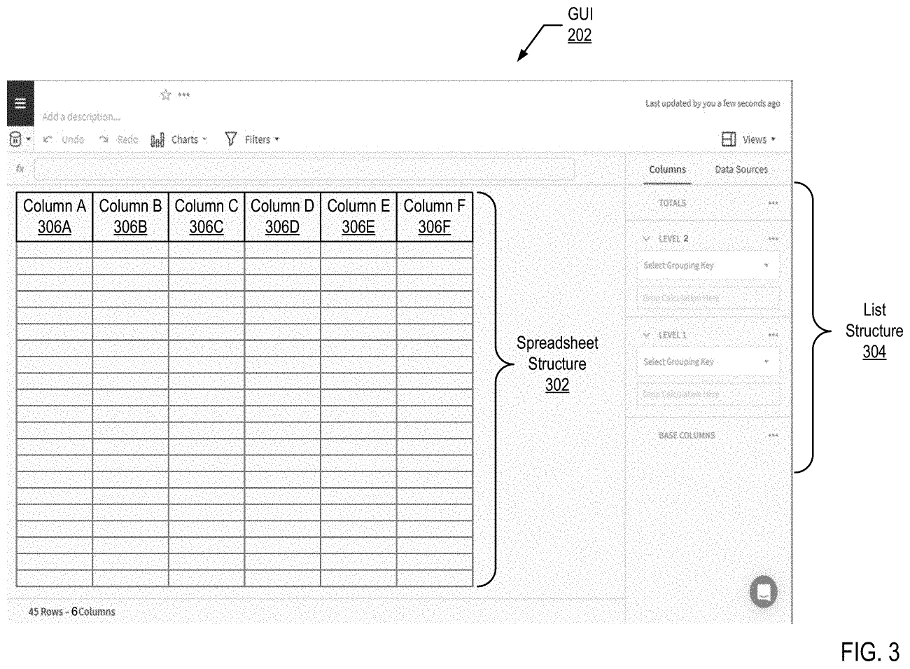

FIG. 3 shows an exemplary graphical user interface (GUI) for linking and composing worksheets according to embodiments of the present invention. As shown in FIG. 3, the exemplary GUI (202) includes a spreadsheet structure (302) and a list structure (304). The spreadsheet structure (302) includes a data set (shown as empty rows) with six columns (column A (306A), column B (306B), column C (306C), column D (306D), column E (306E), column F (306F)).

The spreadsheet structure (302) is a graphical element and organizing mechanism for the data set. The spreadsheet structure (302) displays the data within the data set as rows of data organized by columns (column A (306A), column B (306B), column C (306C), column D (306D), column E (306E), column F (306F)). The columns delineate different categories of the data in each row of the data set. The columns may also be calculations using other columns in the data set.

The list structure (304) is a graphical element used to define and organize the hierarchical relationships between the columns (column A (306A), column B (306B), column C (306C), column D (306D), column E (306E), column F (306F)) of the data set. The term “hierarchical relationship” refers to subordinate and superior groupings of columns. For example, a database may include rows for an address book, and columns for state, county, city, and street. A data set from the database may be grouped first by state, then by county, and then by city. Accordingly, the state column would be at the highest level in the hierarchical relationship, the county column would be in the second level in the hierarchical relationship, and the city column would be at the lowest level in the hierarchical relationship.

The list structure (304) presents a dimensional hierarchy to the user. Specifically, the list structure (304) presents levels arranged hierarchically across at least one dimension. Each level within the list structure (304) is a position within a hierarchical relationship between columns (column A (306A), column B (306B), column C (306C), column D (306D), column E (306E), column F (306F)). The keys within the list structure (304) identify the one or more columns that are the participants in the hierarchical relationship. Each level may have more than one key.

One of the levels in the list structure (304) may be a base level. Columns selected for the base level provide data at the finest granularity. One of the levels in the list structure (304) may be a totals or root level. Columns selected for the totals level provide data at the highest granular level. For example, the totals level may include a field that calculates the sum of each row within a single column of the entire data set (i.e., not partitioned by any other column).

The GUI (202) may enable a user to drag and drop columns (column A (306A), column B (306B), column C (306C), column D (306D), column E (306E), column F (306F)) into the list structure (304). The order of the list structure (304) may specify the hierarchy of the columns relative to one another. A user may be able to drag and drop the columns in the list structure (304) at any time to redefine the hierarchical relationship between columns. The hierarchical relationship defined using the columns selected as keys in the list structure (304) may be utilized in charts such that drilling down (e.g., double click on a bar), enables a new chart to be generated based on a level lower in the hierarchy.

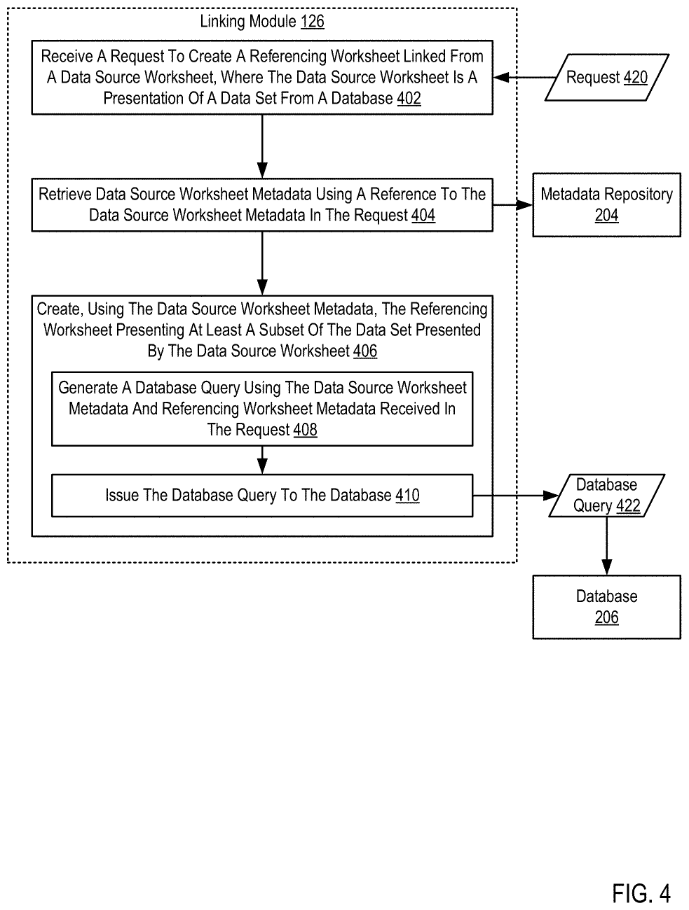

For further explanation, FIG. 4 sets forth a flow chart illustrating an exemplary method for linking and composing worksheets according to embodiments of the present invention that includes receiving (402) a request (420) to create a referencing worksheet linked from a data source worksheet, wherein the data source worksheet is a presentation of a data set from a database. Receiving (402) a request (420) to create a referencing worksheet linked from a data source worksheet, wherein the data source worksheet is a presentation of a data set from a database may be carried out by the linking module (126) receiving the request (420) from a user to generate the referencing worksheet using a data source worksheet. The referencing worksheet metadata may be generated and populated using the contents of request (420).

The request (420) may include a reference to the data source worksheet and a selection of columns from the data source worksheet. The request may include a selection of all columns to present the entire data set from the data source worksheet. Alternatively, the request may include a selection of fewer than all columns to present a subset of the data set from the data source worksheet. The request (420) may include other selections from the data source worksheet, such as an indication as to whether the referencing worksheet is to inherit the presentation structure of the data source worksheet (i.e., formatting).

The request (420) may also be generated by the linking module (126) or other element of the database query generator. For example, a request (420) may be generated in response to other actions taken by a user. If two users are editing the same worksheet and a first user commits changes to the worksheet while the second user has changes pending, the linking module (126) may use a previous version of the worksheet as a data source worksheet to generate a referencing worksheet, and then apply the second user's changes to the referencing worksheet.

The method of FIG. 4 further includes retrieving (404) data source worksheet metadata using a reference to the data source worksheet metadata in the request (420). Retrieving (404) data source worksheet metadata using a reference to the data source worksheet metadata in the request (420) may be carried out by the linking module (126) parsing the request for the reference to the data source worksheet metadata and then retrieving the data source worksheet metadata from a metadata repository (204) using the reference.

The method of FIG. 4 further includes creating (406), using the data source worksheet metadata, the referencing worksheet presenting at least a subset of the data set presented by the data source worksheet. Creating (406) the referencing worksheet includes generating (408) a database query (422) using the data source worksheet metadata and referencing worksheet metadata received in the request (420); and issuing (410) the database query (422) to the database (206). The request (420) may indicate that the referencing worksheet should display the entire data set presented in the data source worksheet or a subset of the data set.

Generating (408) a database query (422) using the data source worksheet metadata and referencing worksheet metadata received in the request (420) may be carried out by the linking module (126) using the description of the data set, the formulas to be applied to the data set, and the presentation structure of the data set in the data source worksheet metadata and the referencing worksheet metadata populated by the request. The database query (422) may be an SQL statement. Issuing (410) the database query (422) to the database (206) may be carried out by the linking module (126) sending the generated database query (422) over a wide area network to the database (206) on the cloud-based data warehouse (192).

The above limitations improve the operation of the computer system by allowing work on a first worksheet to be reused in subsequent worksheets linked from the first worksheet. Specifically, a single general data source worksheet may be generated and maintained, and one or more referencing worksheets may be linked from the data source worksheet. The referencing worksheets may then reuse the work done on the data source worksheet and each referencing worksheet may be tailored for a more specific purpose. This is accomplished by retrieving the data source worksheet metadata and creating the referencing worksheet to presenting at least a subset of the data set presented by the data source worksheet.

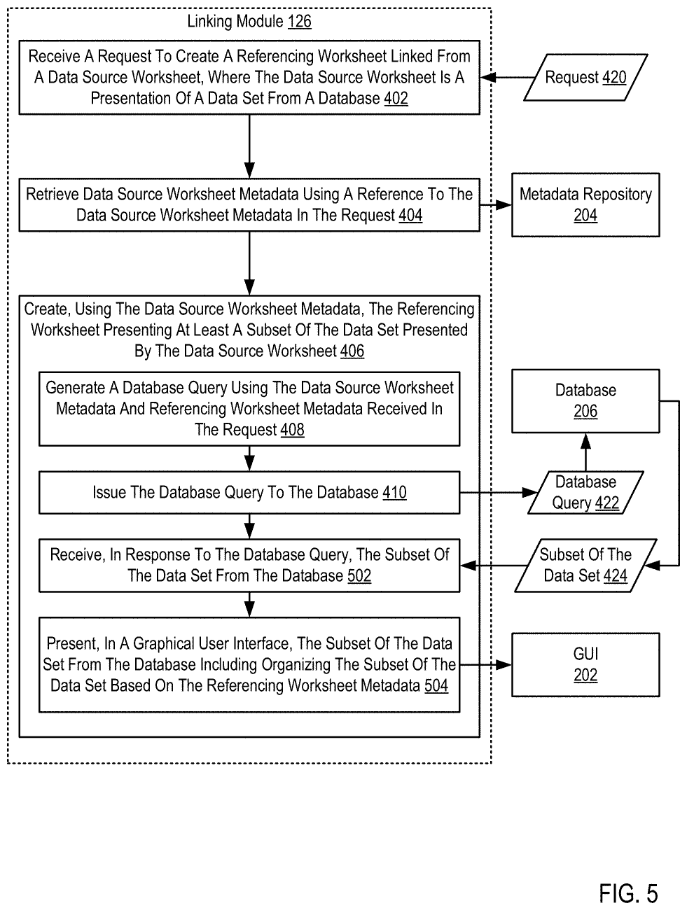

For further explanation, FIG. 5 sets forth a flow chart illustrating a further exemplary method for linking and composing worksheets according to embodiments of the present invention that includes receiving (402) a request (420) to create a referencing worksheet linked from a data source worksheet, wherein the data source worksheet is a presentation of a data set from a database; retrieving (404) data source worksheet metadata using a reference to the data source worksheet metadata in the request (420); and creating (406), using the data source worksheet metadata, the referencing worksheet presenting at least a subset of the data set presented by the data source worksheet, wherein creating (406) the referencing worksheet comprises: generating (408) a database query (422) using the data source worksheet metadata and referencing worksheet metadata received in the request (420); and issuing (410) the database query (422) to the database (206).

The method of FIG. 5 differs from the method of FIG. 4, however, in that creating (406), using the data source worksheet metadata, the referencing worksheet presenting at least a subset of the data set presented by the data source worksheet further comprises receiving (502), in response to the database query (422), the subset of the data set (424) from the database (424); and presenting (504), in a graphical user interface (202), the subset of the data set from the database (424) including organizing the subset of the data set (424) based on the referencing worksheet metadata.

Receiving (502), in response to the database query (422), the subset of the data set from the database (424) may be carried out by the linking module (126) obtaining at least the subset of the data set from the database. Presenting (504), in a graphical user interface (202), the subset of the data set (424) from the database (424) including organizing the subset of the data set (424) based on the referencing worksheet metadata may be carried out by the linking module (126) generating the referencing worksheet from the referencing worksheet metadata and received subset of the data set (324). Presenting the subset of the data set (424) may include applying any presentation structures from the data source worksheet metadata or the request (420).

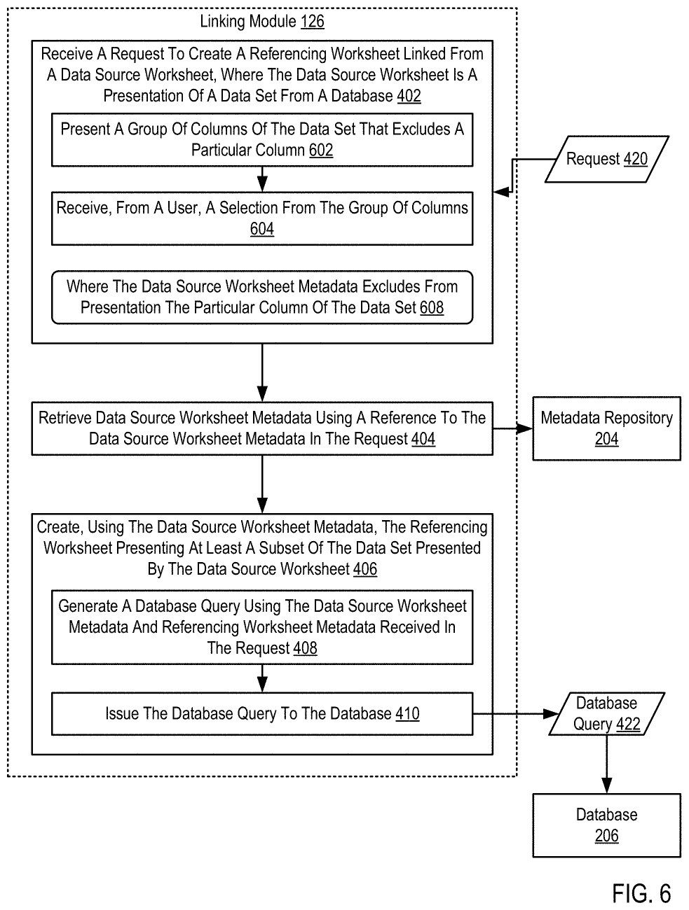

For further explanation, FIG. 6 sets forth a flow chart illustrating a further exemplary method for linking and composing worksheets according to embodiments of the present invention that includes receiving (402) a request (420) to create a referencing worksheet linked from a data source worksheet, wherein the data source worksheet is a presentation of a data set from a database; retrieving (404) data source worksheet metadata using a reference to the data source worksheet metadata in the request (420); and creating (406), using the data source worksheet metadata, the referencing worksheet presenting at least a subset of the data set presented by the data source worksheet, wherein creating (406) the referencing worksheet comprises: generating (408) a database query (422) using the data source worksheet metadata and referencing worksheet metadata received in the request (420); and issuing (410) the database query (422) to the database (206).

The method of FIG. 6 differs from the method of FIG. 4, however, in that receiving (402) a request (420) to create a referencing worksheet linked from a data source worksheet, wherein the data source worksheet is a presentation of a data set from a database, includes presenting (602) a group of columns of the data set that excludes the particular column; and receiving (604), from a user, a selection from the group of columns, wherein (608) the data source worksheet metadata excludes from presentation a particular column of the data set.

Presenting (602) a group of columns of the data set that excludes the particular column may be carried out by the linking module (126) receiving an initial request to create a referencing worksheet linked from a data source worksheet. In response the linking module (126) may present, to the user, a list of columns available for the referencing worksheet. The list of columns available for the referencing worksheet may not include any column excluded from presentation in the data source worksheet. For example, if a column is hidden by the creator of the data source worksheet, then that hidden column may not be included in the list of columns available for the referencing worksheet.

Excluding, in the data source worksheet metadata, from presentation a particular column of the data set may be carried out by the user generating the data source worksheet manipulating the worksheet such that the particular column is not displayed in the GUI. Such manipulations may include hiding the column from view.

For example, groups that generate an underlying data source worksheet may desire particular data to be private from other groups or users in an organization (e.g. salaries of a particular group). To that end, a column in an underlying worksheet may be hidden. The column, once hidden, remains active in the data source worksheet and the data within the column is accessible for other calculations within the data source worksheet. However, a referencing worksheet may not access the hidden column (or even view the hidden column). However, columns in the underlying data source worksheet that rely on a hidden column may still be accessible. Consider, as an example, that salaries of each individual of a particular group are in a first column that is hidden in an underlying data source worksheet. Another column in the underlying data source worksheet, which is not hidden, may calculate the total overhead expenses of that particular group, utilizing as input the hidden salary column. A referencing worksheet will not be able to access the salary column but may access the total overhead expenses column.

Changes made to an excluded column may be reflected in visible columns that utilize that data. Continuing with the example, if salary data is changed at the database or in a calculation column that is hidden from the referencing worksheet, calculations that depend on that salary data may also be updated throughout the data source worksheet and any referencing worksheets.

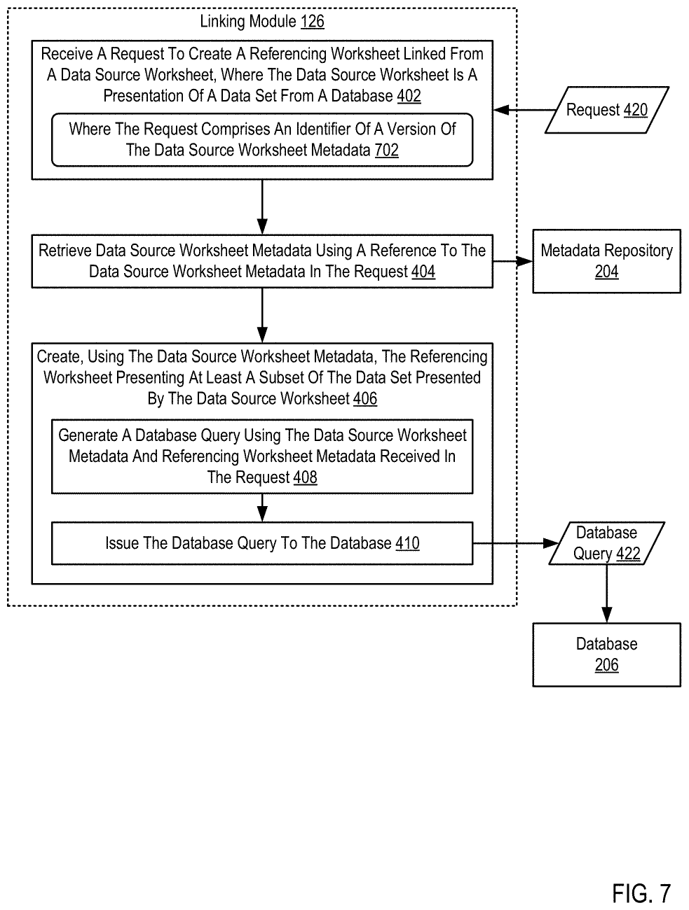

For further explanation, FIG. 7 sets forth a flow chart illustrating a further exemplary method for linking and composing worksheets according to embodiments of the present invention that includes receiving (402) a request (420) to create a referencing worksheet linked from a data source worksheet, wherein the data source worksheet is a presentation of a data set from a database; retrieving (404) data source worksheet metadata using a reference to the data source worksheet metadata in the request (420); and creating (406), using the data source worksheet metadata, the referencing worksheet presenting at least a subset of the data set presented by the data source worksheet, wherein creating (406) the referencing worksheet comprises: generating (408) a database query (422) using the data source worksheet metadata and referencing worksheet metadata received in the request (420); and issuing (410) the database query (422) to the database (206).

The method of FIG. 7 differs from the method of FIG. 4, however, in that receiving (402) a request (420) to create a referencing worksheet linked from a data source worksheet, wherein the data source worksheet is a presentation of a data set from a database, includes wherein (702) the request comprises an identifier of a version of the data source worksheet metadata. The linking module (126) may receive the request (420) and detect, within the request (420), an identifier of a version of the data source worksheet metadata. The linking module (126) may then use that identifier to retrieve the targeted version of the data source worksheet.

As a worksheet is edited, the user may be presented with an option to commit the edits as a new version of the worksheet. Changes to a data source worksheet may be inherited by the referencing worksheets linked from that data source worksheet. Therefore, referencing worksheets may be linked from a particular version of the data source worksheet so that edits made to the data source worksheet and committed as a new version of the data source worksheet are not automatically inherited by the referencing worksheet. A user of the referencing worksheet may explicitly decide to incorporate the edits by linking the referencing worksheet to the updated version of the data source worksheet.

For example, if a referencing worksheet utilizes a ‘county’ column from a data source worksheet, and later the ‘county’ column is deleted, the referencing worksheet may become unusable. If, however, the data source worksheet with the deleted ‘county’ column is saved as a new version, the referencing worksheet may continue to be linked from the previous version of the data source worksheet. The user of the referencing worksheet may explicitly relink from the newer version of the data source worksheet if the changes will not cause the referencing worksheet to become unusable.

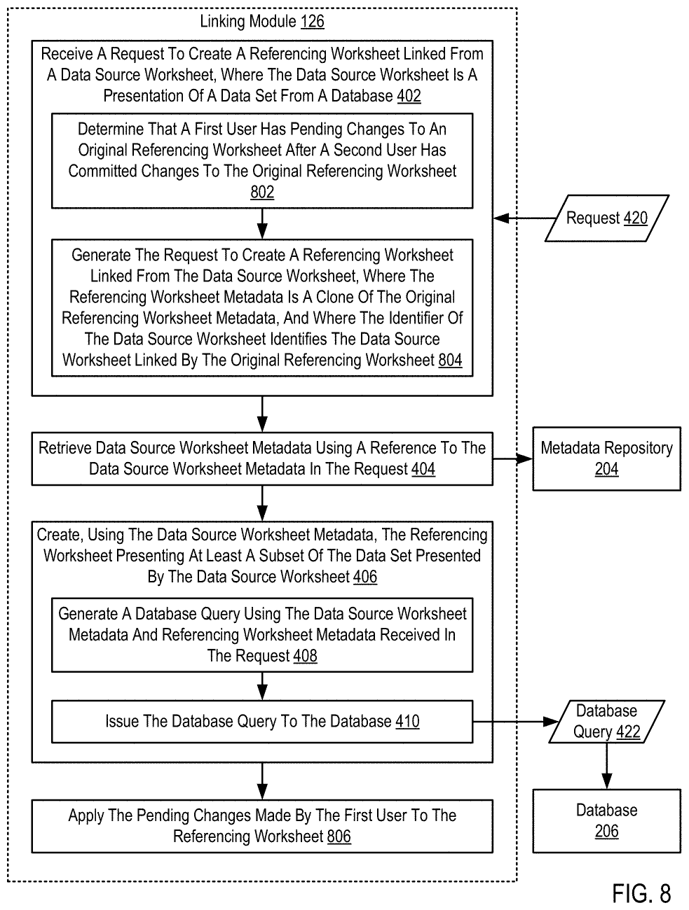

For further explanation, FIG. 8 sets forth a flow chart illustrating a further exemplary method for linking and composing worksheets according to embodiments of the present invention that includes receiving (402) a request (420) to create a referencing worksheet linked from a data source worksheet, wherein the data source worksheet is a presentation of a data set from a database; retrieving (404) data source worksheet metadata using a reference to the data source worksheet metadata in the request (420); and creating (406), using the data source worksheet metadata, the referencing worksheet presenting at least a subset of the data set presented by the data source worksheet, wherein creating (406) the referencing worksheet comprises: generating (408) a database query (422) using the data source worksheet metadata and referencing worksheet metadata received in the request (420); and issuing (410) the database query (422) to the database (206).

The method of FIG. 8 differs from the method of FIG. 4, however, in that receiving (402) a request (420) to create a referencing worksheet linked from a data source worksheet, wherein the data source worksheet is a presentation of a data set from a database, includes determining (802) that a first user has pending changes to an original referencing worksheet after a second user has committed changes to the original referencing worksheet; and generating (804) the request (420) to create a referencing worksheet linked from the data source worksheet, wherein the referencing worksheet metadata is a clone of the original referencing worksheet metadata, and wherein the identifier of the data source worksheet identifies the data source worksheet linked by the original referencing worksheet.

Determining (802) that a first user has pending changes to an original referencing worksheet after a second user has committed changes to the original referencing worksheet may be carried out by the linking module (126) determining that edits have been made by a first user, but the first user did commit the edits to the original referencing worksheet before the original referencing worksheet was changed by the second user. In order to preserve the pending changes made by the first user, a new referencing worksheet is created to which the pending changes are made. This process may be referred to as rebasing.

Generating (804) the request (420) to create a referencing worksheet linked from the data source worksheet, wherein the referencing worksheet metadata is a clone of the original referencing worksheet metadata, and wherein the identifier of the data source worksheet identifies the data source worksheet linked by the original referencing worksheet may be carried out by the linking module (126) creating the request (420) that includes new referencing worksheet metadata cloned from the original referencing worksheet metadata, including a reference to the data source worksheet metadata. The cloned referencing worksheet metadata may be identical to the original referencing worksheet metadata but for the changes made by the second user.

The method of FIG. 8 also differs from the method of FIG. 4, in that the method of FIG. 8 further includes applying (806) the pending changes made by the first user to the referencing worksheet. Applying (806) the pending changes made by the first user to the referencing worksheet may be carried out by the linking module (126) making the pending edits to the new referencing worksheet.

For example, a first user and a second user may be editing version 0 of a first referencing worksheet linked from a data source worksheet. The second user commits the changes to the first referencing worksheet to generate version 1 of the first referencing worksheet. Once the first user attempts to commit their pending changes, a second referencing worksheet is cloned from version 0 of the first referencing worksheet and is linked from the same data source worksheet. The pending changes are made to version 0 of the second referencing worksheet to create version 1 of the second referencing worksheet. This may occur automatically, without input from the first user, or in response to input from the first user. The first referencing worksheet and the second referencing worksheet are no longer related but for being linked from the same data source worksheet.

In view of the explanations set forth above, readers will recognize that the benefits of linking and composing worksheets according to embodiments of the present invention include:
Improving the operation of a computing system by allowing work on a worksheet to be reused in subsequent worksheets linked from that worksheet, increasing computing system efficiency and usability.
Improving the operation of a computing system by providing users of referencing worksheets access to computations using sensitive data without providing access to the sensitive data itself, increasing computing system usability and security.
Improving the operation of a computing system by generating and maintaining a single general data source worksheet that is reused by any number of referencing worksheet tailored for a more specific purpose, increasing computing system efficiency and usability.

Exemplary embodiments of the present invention are described largely in the context of a fully functional computer system for linking and composing worksheets. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of linking and composing worksheets, the method comprising:
receiving a request to create a referencing worksheet linked from a data source worksheet, wherein the data source worksheet is a presentation of a data set from a database;
retrieving data source worksheet metadata using a reference to the data source worksheet metadata in the request; and
creating, using the data source worksheet metadata, the referencing worksheet presenting at least a subset of the data set presented by the data source worksheet, wherein creating the referencing worksheet comprises:
generating a database query using the data source worksheet metadata and referencing worksheet metadata received in the request; and
issuing the database query to the database.

2. The method of claim 1, wherein creating the referencing worksheet further comprises:
receiving, in response to the database query, the subset of the data set from the database; and
presenting, in a graphical user interface, the subset of the data set from the database including organizing the subset of the data set based on the referencing worksheet metadata.

3. The method of claim 1,
wherein the data source worksheet metadata excludes from presentation a particular column of the data set; and
wherein receiving the request to create the referencing worksheet linked from the data source worksheet comprises:
presenting a group of columns of the data set that excludes the particular column; and
receiving, from a user, a selection from the group of columns.

4. The method of claim 1, wherein the request comprises an identifier of a version of the data source worksheet metadata.

5. The method of claim 1,
wherein receiving the request to create the referencing worksheet linked from the data source worksheet comprises:
determining that a first user has pending changes to an original referencing worksheet after a second user has committed changes to the original referencing worksheet; and
generating the request to create a referencing worksheet linked from the data source worksheet, wherein the referencing worksheet metadata is a clone of the original referencing worksheet metadata, and wherein the identifier of the data source worksheet identifies the data source worksheet linked by the original referencing worksheet, and
wherein the method of claim 1 further comprises applying the pending changes made by the first user to the referencing worksheet.

6. The method of claim 1, wherein the referencing worksheet metadata comprises an identifier of at least one column presented in the data source worksheet.

7. The method of claim 1, wherein the referencing worksheet metadata comprises an identifier of additional data source worksheet metadata for an additional data source worksheet.

8. An apparatus for linking and composing worksheets, the apparatus comprising a computer processor, a computer memory operatively coupled to the computer processor, the computer memory having disposed within it computer program instructions that, when executed by the computer processor, cause the apparatus to carry out the steps of: receiving a request to create a referencing worksheet linked from a data source worksheet, wherein the data source worksheet is a presentation of a data set from a database;
retrieving data source worksheet metadata using a reference to the data source worksheet metadata in the request; and
creating, using the data source worksheet metadata, the referencing worksheet presenting at least a subset of the data set presented by the data source worksheet, wherein creating the referencing worksheet comprises:
generating a database query using the data source worksheet metadata and referencing worksheet metadata received in the request; and
issuing the database query to the database.

9. The apparatus of claim 8, wherein creating the referencing worksheet further comprises:
receiving, in response to the database query, the subset of the data set from the database; and
presenting, in a graphical user interface, the subset of the data set from the database including organizing the subset of the data set based on the referencing worksheet metadata.

10. The apparatus of claim 8,
wherein the data source worksheet metadata excludes from presentation a particular column of the data set; and
wherein receiving the request to create the referencing worksheet linked from the data source worksheet comprises:
presenting a group of columns of the data set that excludes the particular column; and
receiving, from a user, a selection from the group of columns.

11. The apparatus of claim 8, wherein the request comprises an identifier of a version of the data source worksheet metadata.

12. The apparatus of claim 8,
wherein receiving the request to create the referencing worksheet linked from the data source worksheet comprises:
determining that a first user has pending changes to an original referencing worksheet after a second user has committed changes to the original referencing worksheet; and
generating the request to create a referencing worksheet linked from the data source worksheet, wherein the referencing worksheet metadata is a clone of the original referencing worksheet metadata, and wherein the identifier of the data source worksheet identifies the data source worksheet linked by the original referencing worksheet, and
wherein the method of claim 1 further comprises applying the pending changes made by the first user to the referencing worksheet.

13. The apparatus of claim 8, wherein the referencing worksheet metadata comprises an identifier of at least one column presented in the data source worksheet.

14. The apparatus of claim 8, wherein the referencing worksheet metadata comprises an identifier of additional data source worksheet metadata for an additional data source worksheet.

15. A computer program product for linking and composing worksheets, the computer program product disposed upon a computer readable medium, the computer program product comprising computer program instructions that, when executed, cause a computer to carry out the steps of:
receiving a request to create a referencing worksheet linked from a data source worksheet, wherein the data source worksheet is a presentation of a data set from a database;
retrieving data source worksheet metadata using a reference to the data source worksheet metadata in the request; and
creating, using the data source worksheet metadata, the referencing worksheet presenting at least a subset of the data set presented by the data source worksheet, wherein creating the referencing worksheet comprises:
generating a database query using the data source worksheet metadata and referencing worksheet metadata received in the request; and
issuing the database query to the database.

16. The computer program product of claim 15, wherein creating the referencing worksheet further comprises:
receiving, in response to the database query, the subset of the data set from the database; and
presenting, in a graphical user interface, the subset of the data set from the database including organizing the subset of the data set based on the referencing worksheet metadata.

17. The computer program product of claim 15,
wherein the data source worksheet metadata excludes from presentation a particular column of the data set; and
wherein receiving the request to create the referencing worksheet linked from the data source worksheet comprises:
presenting a group of columns of the data set that excludes the particular column; and
receiving, from a user, a selection from the group of columns.

18. The computer program product of claim 15, wherein the request comprises an identifier of a version of the data source worksheet metadata.

19. The computer program product of claim 15,
wherein receiving the request to create the referencing worksheet linked from the data source worksheet comprises:
determining that a first user has pending changes to an original referencing worksheet after a second user has committed changes to the original referencing worksheet; and
generating the request to create a referencing worksheet linked from the data source worksheet, wherein the referencing worksheet metadata is a clone of the original referencing worksheet metadata, and wherein the identifier of the data source worksheet identifies the data source worksheet linked by the original referencing worksheet, and
wherein the method of claim 1 further comprises applying the pending changes made by the first user to the referencing worksheet.

20. The computer program product of claim 15, wherein the referencing worksheet metadata comprises an identifier of at least one column presented in the data source worksheet.
